(19) United States
(12) Patent Application Publication
(10) Pub. No.: US 2025/0318907 A1
(43) Pub. Date: Oct. 16, 2025

(54) PROCESSES FOR MAKING CLEAR DENTAL ALIGNERS AND CLEAR DENTAL ALIGNERS PRODUCED BY THE PROCESSES

(71) Applicant: PDR/ORCHESTRATE LLC, Ardmore, CA (US)

(72) Inventors: Ronald A. BULARD, Ardmore, CA (US); Todd EHRLER, Redlands, CA (US)

(73) Assignee: PDR/ORCHESTRATE LLC, Ardmore, CA (US)

(21) Appl. No.: 18/866,810

(22) PCT Filed: May 18, 2023
(86) PCT No.: PCT/US2023/022653

§ 371 Date: Nov. 18, 2024

Related U.S. Application Data
(60) Provisional application No. 63/343,147, filed on May 18, 2022.
(60) Provisional application No. 63/460,834, filed on Apr. 20, 2023.

(51) Int. Cl. A61C 7/08; A61C 7/00; B33Y 80/00

(52) U.S. Cl. CPC A61C 7/08; A61C 7/002; B33Y 80/00

(57) ABSTRACT

Processes for producing dental aligners and/or appliances and dental aligners and/or appliances produced by the processes are provided, wherein the processes comprise making a scan of teeth of a patient and developing a treatment plan for moving at least one tooth of the teeth from an original or first position to a new, final, or second position. The processes further comprise developing a force vector matrix, wherein the force vector matrix comprises all variables that are known to contribute to force generation of an orthodontic appliance on a patient's tooth, and 3D printing the dental aligner or appliance based on the developed treatment plan, the developed force vector matrix, and/or the scan of the teeth of the patient.

### CROSS-REFERENCE TO RELATED APPLICATION

This non-provisional application claims priority to U.S. Provisional Patent Application Nos. 63/343,147 filed May 18, 2022 and 63/460,834 filed Apr. 20, 2023, which are both incorporated herein by reference.

### FIELD OF THE DISCLOSURE

The present disclosure is directed to processes for making clear dental aligners and/or tooth movement appliances and the clear dental aligners and/or tooth movement appliances produced by the processes.

### BACKGROUND OF THE DISCLOSURE

The statements in this section merely provide background information related to the present disclosure and do not constitute prior art.

Typically, 3D printing of one or more dental appliances is known, both by indirect and direct methodologies.

It is an object of the present disclosure to provide an alternative methodology for direct 3D printing of dental aligners and/or tooth movement appliances that makes the processing more efficient such that the aligners and/or appliances obtained may be more accurate and/or may provide an improved ability to control forces applied the teeth; thus, the aligners and/or appliances disclosed herein may be more beneficial to the patient and/or the treatment plan of the patient.

### SUMMARY OF THE DISCLOSURE

This summary is provided to introduce a selection of concepts that are further described below in the detailed description. This summary is not intended to identify key or essential features of the claimed subject matter, nor is it intended to be used as an aid in limiting the scope of the claimed subject matter.

The present disclosure relates in a first embodiment to process for producing at least one dental aligner for a patient, said process may comprise:
(a) making a scan of teeth of a patient;
(b) developing a treatment plan based on the scan of the teeth for moving at least one tooth of the patient from an original or first position to a new or second position;
(c) developing a force vector matrix, wherein the force vector matrix comprises all variables that are known to contribute to force generation of an orthodontic appliance on the tooth of the patient, wherein force properties necessary to move the at least one tooth of the patient from the original or first position to the new or second position are determined, identified, and/or calculated based on the developed force vector matrix; and
(d) 3D printing a dental aligner based one or more inputs combined from the scan, the developed force vector matrix, and/or the determined force properties.

In some embodiments, said process may further comprise:
providing fabrication instructions from software executable on a computer to a 3D printer for 3D printing the dental aligner, wherein the 3D printed dental aligner may comprise one or more force augmentation geometries for applying the determined force properties to the at least one tooth such that the determined force properties applied by the one or more force augmentation geometries moves the at least one tooth of the patient from the original or first position to the new or second position.

In an embodiment, the one or more force augmentation geometries for applying the determined force properties may comprise: one or more interior surfaces of the 3D printed dental aligner that contact or abut the at least one tooth or the teeth of the patient: one or more force augmentation generators disposed on one or more exterior surfaces of the 3D printed dental aligner; one or more force augmentation generators integrally-formed with the 3D printed dental aligner; one or more force augmentation generators removably attachable to the 3D printed dental aligner; one or more force augmentation generators insertable into one or more housings or receptacles disposed on one or more exterior surfaces of the 3D printed dental aligner; one or more force augmentation generators configured or adapted to apply constrictive forces or expansive forces onto the at least one tooth or the teeth of the patient; or a combination thereof.

In an embodiment, the process may further comprise selectively light curing, via the 3D printer, the liquid resin into a solid surface based on the provided fabrication instructions, wherein the solid surface may comprise one or more exterior surfaces and/or one or more interior surfaces of the 3D printed dental aligner, one or more force augmentation geometries for applying the determined force properties to the at least one tooth or the teeth of the patient, and/or one or more force augmentation generators disposed on the solid surface of the 3D printed dental aligner.

In one or more embodiments, the developed treatment plan may be based on, or at least partially based on, the scan of the teeth, the original or first position, the new or second position, one or more visual observations of the teeth, at least one digital twin or avatar of the teeth or the scan of the teeth, or a combination thereof. Additionally, the developed force vector matrix may be based on, or at least partially based on, the scan of the teeth, the original or first position, the new or second position, the developed treatment plan, at least one digital twin or avatar of the teeth or the scan of the teeth, or a combination thereof. Further, the 3D printed dental aligner may be based on, or at least partially based on, the scan of the teeth, the original or first position, the new or second position, the developed treatment plan, the developed force vector matrix, at least one digital twin or avatar of the teeth or the scan of the teeth, or a combination thereof. Still further, the provided fabrication instructions may be based on, or at least partially based on, the scan of the teeth, the original or first position, the new or second position, the developed treatment plan, the developed force vector matrix, at least one digital twin or avatar of the teeth or the scan of the teeth, or a combination thereof.

The present disclosure relates in a second embodiment to a clear dental aligner produced by or in accordance with the process of the first embodiment.

In one or more embodiments, processes produce dental aligners and the processes comprise: (a) making a scan of teeth of a patient; (b) developing a treatment plan based on the scan of the teeth for moving at least one tooth of the teeth from a first position to a second position; (c) developing a force vector matrix based on the developed treatment plan, wherein the force vector matrix comprises a plurality of variables that are known to contribute to force generation of an orthodontic appliance on a patient's tooth; and (d) 3D printing a dental aligner via a 3D printer and based one or more inputs from the scan of the teeth, the developed treatment plan, and/or the developed force vector matrix and comprising a force augmentation geometry, wherein, when the 3D printed dental aligner is worn in the mouth of the patent, the force augmentation geometry applies force(s) onto the at least one tooth of the teeth such that the forces applied by the force augmentation geometry moves the at least one tooth from the first position to the second position.

In an embodiment, the 3D printed dental aligner comprises one or more exterior surfaces and one or more interior surfaces opposite with respect to the one or more exterior surfaces, and

In an embodiment, the force augmentation geometry for applying the force(s) onto the at least one tooth comprises at least one selected from: the one or more interior surfaces of the 3D printed dental aligner; and a force augmentation generator disposed on the one or more exterior surfaces of the 3D printed dental aligner.

In an embodiment, the processes further comprise moving the at least one tooth from the first position to the second position according to the developed treatment plan with the force(s) applied to the at least one tooth by the force augmentation geometry.

In an embodiment, the force augmentation geometry comprises at least the force augmentation generator for applying the force(s) onto the at least one tooth.

In an embodiment, the processes further comprise integrally-forming the force augmentation generator on or with the one or more exterior surfaces of the 3D printed dental aligner via the 3D printer.

In an embodiment, the integrally-formed force augmentation generator is in a form of at least one bar, at least one band, or at least one wire.

In an embodiment, the processes further comprising integrally-forming a receptacle on the one or more exterior surfaces of the 3D printed dental aligner via the 3D printer, wherein the integrally-formed receptacle is sized and/or shaped to receive the force augmentation generator such that the force augmentation generator is removably attached to the 3D printed dental aligner via the receptacle.

In an embodiment, the force augmentation generator is in a form of at least insertable one bar, at least one insertable band, at least insertable one spring, or at least one insertable wire.

In an embodiment, the integrally-formed receptacle is a tunnel and the force augmentation generator is in the form of at least one insertable spring or at least one insertable wire.

In an embodiment, the processes further comprise integrally-forming one or more fasteners on or with the one or more exterior surfaces of the 3D printed dental aligner via the 3D printer, wherein the force augmentation generator is extendible around or over the integrally-formed one or more fasteners such that the force augmentation generator is removable attached to the 3D printed dental aligner via the integrally-formed one or more fasteners.

In an embodiment, the force augmentation generator is at least one extendible elastic or rubber band.

In an embodiment, the integrally-formed one or more fasteners comprise hooks, posts, and/or tabs.

In one or more embodiments, one or more 3D printed dental aligners comprise: an exterior surface and an interior surface opposite with respect to the exterior surfaces, wherein the exterior surface and the interior surface are formed with at least one cured resin material and a 3D printer, wherein the interior surface faces and/or contacts one or more teeth of a patient and outer surfaces of the exterior surface face or contact lips and/or gums of the patient when the 3D printed dental aligner is worn in a mouth of the patient; and at least one force augmentation generator disposed on the exterior surface, wherein: the at least one force augmentation generator applies force(s) to one or more teeth of the patient based on a developed force vector matrix and moves the one or more teeth of the patient from a first position to a second position when the 3D printed dental aligner is worn in the mouth of the patient, and the developed force vector matrix is based on a developed treatment plan that is based on a scan of teeth of the patient.

In an embodiment, the exterior surface comprises inner surfaces located opposite with respect to the outer surfaces of the exterior surface, and the at least one force augmentation generator is disposed on the outer surfaces for applying constrictive force(s) to treat spacing between at least two teeth of the patient or the inner surfaces for applying expansive force(s) to treat at least two overlapping teeth of the patient.

In an embodiment, the at least one force augmentation generator is integrally-formed on or with outer surfaces or the inner surface of the exterior surface via the 3D printer and in a form of at least one bar, at least one band, or at least one wire.

In an embodiment, the at least one force augmentation generator is removable attachable to the outer surfaces or the inner surfaces of the exterior surface.

In an embodiment, the exterior surface further comprises at least one receptacle integrally-formed on or with the exterior surface via the 3D printer and sized and/or shaped to receive the at least one force augmentation generator such that the at least one force augmentation generator is removably attached to the exterior surface via the at least one receptacle when the at least one force augmentation generator is inserted into the at least one receptacle.

In an embodiment, the at least one force augmentation generator is in a form of at least one insertable bar, at least one insertable band, at least one insertable spring, or at least one insertable wire, or the at least one receptacle is a tunnel and the at least one force augmentation generator is in a form of at least one insertable spring or at least one insertable wire.

In an embodiment, the exterior surface further comprises fasteners integrally-formed on or with the exterior surface via the 3D printer and is configured and/or shaped to receive portions of the at least one force augmentation generator such that the at least one force augmentation generator is removably attached to the exterior surface via the fasteners when the at least one force augmentation generator is extended around or over the fasteners.

In an embodiment, the fasteners are hooks and the at least one force augmentation generator comprises one or more elastic or rubber bands.

In an embodiment, the one or more 3D printed dental aligners further comprise at least one fixture disposed on exterior surface, wherein the at least one force augmentation generator is at least one force modulus and, when the 3D printed dental aligner is worn in the mouth of the patient, the at least one force modulus connects the at least one fixture to an anchored implant of the patient.

In an embodiment, the at least one fixture is 3D printed on the exterior surface and comprises at least one hook, at least one pin, at least one lip, at least one flange, at least one ridge, at least one clip, at least one peak, at least one post, at least one tab, or a combination thereof.

In an embodiment, the at least one force modulus comprises one or more springs, one or more coils, one or more elastic and/or rubber bands, or a combination thereof.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 is a flowchart depicting a process for preparing at least one dental aligner and/or tooth movement appliance (collectively referred to hereinafter as “at least one dental aligner”), according to one or more examples of the disclosure.

FIG. 2 is a schematic showing a system for implementing the process(es) disclosed herein and/or preparing at least one dental aligner, according to one or more examples of the disclosure.

FIG. 3 is a perspective first or top side view of a computerized tomography (hereinafter “CT”) scan of at least one dental aligner, according to one or more examples of the disclosure.

FIG. 4 is a perspective side view of a CT scan of at least one dental aligner, according to one or more examples of the disclosure.

FIG. 5 is a perspective front view of a CT scan of at least one dental aligner having at least one force augmentation geometry disposed thereon, according to one or more examples of the disclosure.

FIG. 6 is a perspective back view of a CT scan of at least one dental aligner having at least one force augmentation geometry disposed thereon, according to one or more examples of the disclosure.

FIG. 7 is a perspective front view of a CT scan of at least one dental aligner having at least one force augmentation geometry removably attached thereto, according to one or more examples of the disclosure.

FIG. 8 is a perspective back view of a CT scan of at least one dental aligner having at least one force augmentation geometry removably attached thereto, according to one or more examples of the disclosure.

FIG. 9 is an elevated, perspective front view of a CT scan of at one dental aligner comprising an integrally-formed or removably attached force augmentation geometry or generator, according to one or more examples of the disclosure.

FIG. 10 is a perspective top view of a CT scan of at least one dental aligner having at least one force augmentation generator removable attached thereto via fasteners, according to one or more examples of the disclosure.

FIG. 11 is a perspective back view of a CT scan of at least one dental aligner having at least one force augmentation generator insertable into at least one receptacle or tunnel of the at least one dental aligner, according to one or more examples of the disclosure.

FIG. 12 is a perspective back view of a CT scan of at least one dental aligner having at least one recess disposed between at least two portions of the at least one dental aligner.

FIG. 13 is an elevated, perspective front view of a CT scan of the at least one dental aligner, shown in FIG. 12, having the at least one recess disposed between the at least two portions of the at least one dental aligner.

FIG. 14 is a perspective side view of a CT scan of at least one dental aligner having a fixture that is connectable or attachable to a bone anchored implant or tooth via at least one force modulus, according to one or more examples of the disclosure.

FIG. 15 is a perspective top view of a CT scan of at least ne dental aligner having fixtures connectable or attachable to bone anchored implants or teeth via a plurality of force modulus, according to one or more examples of the disclosure.

FIG. 16 is a perspective side view of a CT scan of at least one dental aligner having fixture that are connectable or attachable to a bone anchored implant or tooth via a plurality of force modulus, according to one or more examples of the disclosure.

### DETAILED DESCRIPTION OF THE PREFERRED EMBODIMENTS

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Further, as used herein, the article “a” is intended to have its ordinary meaning in the patent arts, namely “one or more.” Herein, the term “about” when applied to a value generally means within the tolerance range of the equipment used to produce the value, or in some examples, means plus or minus 10%, or plus or minus 5%, or plus or minus 1%, unless otherwise expressly specified. Further, herein the term “substantially” as used herein means a majority, or almost all, or all, or an amount with a range of about 51% to about 100%, for example. Moreover, examples herein are intended to be illustrative only and are presented for discussion purposes and not by way of limitation.

As used herein, the phrases “selected from the group consisting of,” “chosen from,” and the like include mixtures of the specified materials. Tunis such as “contains”, and the like are meant to include “including at least” unless otherwise specifically noted.

Where a numerical limit or range is stated, the endpoints are included. Also, all values and subranges within a numerical limit or range are specifically included as if explicitly written out.

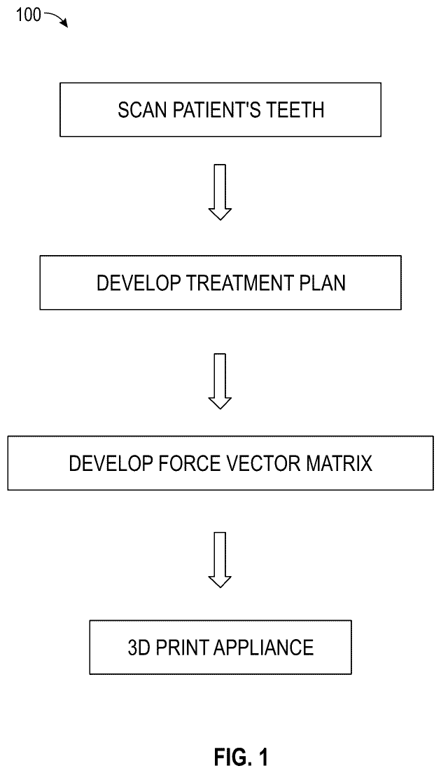

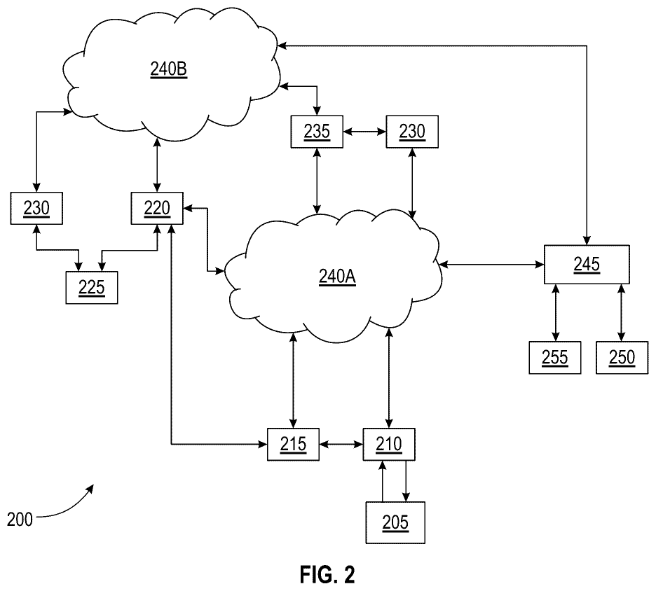

The present disclosure involves a unique methodology for producing at least one dental aligner, one or more dental aligners, at least one tooth movement appliance, or one or more teeth movement appliances (collectively referred to hereinafter as “aligner” or “aligners”). FIG. 1 illustrates one or more steps and/or sub-steps of a process 100 for producing or providing the aligner or the aligners, and FIG. 2 illustrates a system 200 for implementing, facilitating, or achieving the process(es) disclosed herein.

In one or more embodiments, the system 200 shown in FIG. 2 may comprise, include, consist of, and/or have one or more of the following system components and/or system sub-components: teeth of a patient 205 (hereinafter “the teeth 205”); at least one dental scanner 210 (hereinafter “the scanner 210”); at least one 3D digital dental scan 215 of the teeth 205 (hereinafter “the scan 215”); at least one computer 220 (hereinafter “the computer 220”); at least one non-transitory computer-readable medium 225 (hereinafter “the medium 225”); one or more computer-executable instructions 230 (hereinafter “the computer instructions 230”); one or more processors of the computer (not shown in the drawings); at least one database 235 (hereinafter “the database 235”); at least one first digital communication network 240A (hereinafter “the first network 240A”); at least one second digital communication network 240B (hereinafter “the second network 240B”); at least one additive manufacturing or 3D printing device and/or system 245 (hereinafter “the 3D printing system 245”); one or more aligners 250 (hereinafter “the aligner(s) 250”), a set or kit 255 of the aligner(s) 250 (hereinafter “the kit 255”), or a combination thereof. Additionally, at least two of the above-mentioned system components and/or system sub-components may be in either direct digital communication or indirect digital communication with each other as shown by the arrows set forth in FIG. 2. Further, the direct or indirect digital communication between the at least two system components and/or system sub-components may be uni-directional digital communication, bi-directional digital communication, or a combination thereof.

In embodiments, the computer 220 may be one or more portable digital devices, one or more handheld digital devices, one or more computer terminals, or any combination thereof. In embodiments, the computer 220 may be a wired terminal, a wireless terminal, or any combination thereof. For example, the computer 220 may be wireless electronic media device, such as, for example, a tablet personal computer (hereinafter “PC”), an ultra-mobile PC, a mobile-based pocket PC, an electronic book computer, a laptop computer, a video game console, a digital projector, a digital television, a digital radio, a media player, a portable media device, a personal digital assistant, an enterprise digital assistant, and/or any combination thereof. In other embodiments, the computer 220 may be, for example, a hyper local digital device, a location-based digital device, a GPS-based digital device, a mobile device (i.e., a 5G+ mobile device, a 5G mobile device, a 4G mobile device, a 3G mobile device), an ALL-IP electronic device, an information appliance, a personal communicator or any combination thereof. The present disclosure should not be deemed as limited to specific embodiments of the computer 220.

The computer 220 may each have at least one display for displaying or rendering the scan 215 of the teeth 205, the treatment plan, at least one digital twin of the scan 215 or the teeth 205, or a combination thereof at least temporarily stored in a memory, the medium 225, and/or in at least one digital storage device accessible by microprocessors (not shown in the drawings) of the system 200. The at least one digital twin may be, comprise, include, or consist of at least one virtual representation, model, illustration, or avatar that serves as the real-time digital counterpart of the teeth 205, the scan 215, and/or the processes disclosed herein. Further, the at least one digital twin may be modelled or trained by one or more AI-based and/or ML-based software techniques. The digital communications, the multimedia data, and/or digital information associated with the scan 215, the treatment plan, and/or the at least one digital twin may be streamed to the computer 220 via the first network 240A, and/or the computer 220 may be in digital communication with the first network 240A. In an embodiment, one or more digital displays of each of the computer 220 may be or comprise at least one digitized touchscreen and at least one touch-screen graphic user interface (collectively referred to hereinafter as “the GUI”) connected to the microprocessors of the computer 220. In embodiments, the GUI of the first device 102 may facilitate, permit, and/or allow user interaction and/or communication with or between the scanner 210, the computer 220, and/or the 3D printing system 245.

The GUIs of the computer 220 may facilitate, permit, and/or allow interactions and/or communications with the scanner 210, the computer 220, and/or the 3D printing system 245 by way of or via one or more graphical elements, one or more audio elements, and/or text-based elements. In some embodiments, one or more display links of the one or more audio elements may facilitate, permit, and/or allow interactions and/or communication with or between the scanner 210, the computer 220, and/or the 3D printing system 245 via the GUIs of the computer 220. In other embodiments, the GUIs of the computer 220 may facilitate, permit, and/or allow interactions and/or communications with or between the scanner 210, the computer 220, and/or the 3D printing system 245 by way of or via one or more graphical elements and/or one or more display links, instead of through use of a pure text-based elements or interface. The one or more graphical elements, the one or more text-based elements, and/or the one or more display links may be, may comprise, and/or may include one or more windows, one or more icons, one or more widgets, one or more sliders, one or more text boxes, one or more buttons, one or more menus, one or more screens one, or more digital avatars, or any combination thereof. The one or more graphical elements, the one or more text-based elements, and/or the one or more display links may be selected, highlighted, moved, activated, and/executed through use of the GUIs of the computer 220 and/or via at least one pointing device (i.e., a mouse, a stylus, a digital writing device, a human finger or thumb, or a combination thereof) associated with and/or in digital communication with the scanner 210, the computer 220, and/or the 3D printing system 245. The displays, the GUIs, and/or the pointing devices of the computer 220 may be configured and adapted to support touch and multi-touch manipulation by the first user, dental treatment provider, and/or practitioner. In some embodiments, two or more screens of the GUIs of the computer 220 may be linked together into a workflow of the process 100, the system 200, or a combination thereof. The workflow and/or navigation between two or more screens of the GUIs of the computer 220 may be facilitated, executed, and/or performed in one or more process steps indicative of the process 100.

The one or more digital displays and/or the GUIs of at least one of the computer 220 may display, render, provide, and/or facilitate the digital communications, the multimedia data, and the digital information associated with or indicative of the teeth 205, the scan 215, the treatment plan, and/or the digital twin. Moreover, the digital information, digital data and/or multimedia data may be rendered, accessed, and/or activated by the computer 220 which may include one or more web sites, one or more web applications, one or more web pages, digital media, one or more IP addresses, audio files or signals, video files or signals, image files or signals, one or more e-mail servers and/or the like.

In embodiments, the computer 220 may have one or more communication components for connecting to and/or communicating with the first network 240A and/or the second network 240B (collectively referred to hereinafter as “the networks 240A, 204B”). In an embodiment, the one or more communication components of the computer 220 may be a wireless transducer (not shown in the drawings), such as, for example, a wireless sensor network device, such as, for example, a Wi-Fi network device, a wireless ZigBee device, an EnOcean device, an ultra-wideband device, a wireless Bluetooth device, a wireless Local Area Network (hereinafter LAN) accessing device, a wireless IrDA device, or any combination thereof. The present disclosure should not be deemed as limited to specific embodiments of the wireless transducer of the system 200.

The computer 220 may connect to and/or may access the first network 106 via the one or more communication components of the computer 220. In an embodiment, the scanner 210, the computer 220, and/or the 3D printing system 245 may be connected to and/or in digital communication with each other via or over the networks 240A, 240B. In another embodiment, the scanner 210, the computer 220, and/or the 3D printing system 245 may be directly connected to and/or in direct digital communication with each other. In yet another embodiment, a resolver (not shown in the drawings) may be integrated into, or part of, the scanner 210, the computer 220, and/or the 3D printing system 245. In embodiments, the resolver may be an internet and/or intermediary resolver specifically assigned to the scanner 210, the computer 220, and/or the 3D printing system 245 and/or provided by an internet service provider of, or associated with, the scanner 210, the computer 220, and/or the 3D printing system 245.

The scanner 210, the computer 220, and/or the 3D printing system 245 and/or the resolver may be connected to, in digital communication, and/or accessible via the network 420A, 420B of the system 200. As a result, the scanner 210, the computer 220, and/or the 3D printing system 245 and/or the resolver may be in digital communication with at least one server (not shown in the drawings) and may access at least one internet-accessible resource via the networks 240A, 240B. The internet-accessible resource is associated with or indicative of the teeth 205, the scan 215, the treatment plan, and/or the digital twin and may comprises at least one of the multimedia data, the digital communications and/or information, at least one web site, at least one web page, at least one web application, at least one mobile application, at least one e-mail server, digital information, digital data, digital media content, or any combination thereof.

In one or more embodiments, at least one artificial intelligence (hereinafter “AI”) resource/component and/or at least one machine learning software (hereinafter “MLS”) resource/component may be accessible and/or activatable by the computer 220 via the network 420A, 420B. For example, the AI resource/component and/or the MLS resource/component may be stored on medium 225 and/or the database 235 and/or accessible and executable by the computer 220 via the medium 225 and/or the database 235. In some embodiments, the computer 220 may utilize, execute, and/or access the at least one AI-based resource/component and/or ML-based resource/component locally or remotely over a cloud server or other digital communication network. In at least one embodiment, the system 200 may comprise, include, consist of, or provide a cloud-based server that is in digital communication with and accessible by the computer 220 over the networks 420A, 420B.

In embodiments, the computer 220 may be directly connected and/or in direct digital communication with the scanner 210, the medium 225, the database 235, and/or 3D printing system 245 via the networks 240A, 240B. In at least one embodiment, a server of the system 200 may be a cloud-based server that is in digital communication with and accessible by the scanner 210, the computer 220, and/or the 3D printing system 245 over the networks 240A, 240B. As a result, the database 235 may be a cloud-accessible database that is in digital communication with and accessible by the scanner 210, the computer 220, and/or the 3D printing system 245 over the networks 420A, 420B.

In some embodiments, the system 200 comprises at least one AI-enabled software comprising at least one of the AI-based resource/component, the ML-based resource/component, or a combination thereof. For example, the computer instructions 230 may include, comprise, consist of, or provide the at least one AI-enabled software. The AI software may in digital communication with and/or accessible by the scanner 210, the computer 220, and/or the 3D printing system 245 over the networks 240A, 240B. In an embodiment, at least one of the AI software, the resources/components therein, or a combination thereof is cloud-based AI software that is in digital communication with and/or accessible by the scanner 210, the computer 220, and/or the 3D printing system 245 over the networks 240A, 240B. As a result, cloud-based AI software may be implemented and/or executable by at least one of the scanner 210, the computer 220, and/or the 3D printing system 245 over the networks 240A, 240B.

In at least one embodiment, the system 200 is a cloud-based system and one or more of the system components and/or system sub-components of the system 200 are cloud-based system components. In other embodiments, the database 235 is a cloud-bases server such that the scanner 210, the computer 220, and/or the 3D printing system 245 may be in digital communication with and/or may access the database 235 and/or the AI software via the cloud-base server over the networks 240A, 240B.

The database 235 may be a memory or storage medium that is local with respect to the scanner 210, the computer 220, and/or the 3D printing system 245 or may be located remotely with respect to the scanner 210, the computer 220, and/or the 3D printing system 245 whereby “remotely” means positioned at a different physical location than the physical location of the scanner 210, the computer 220, and/or the 3D printing system 245. In an embodiment, the system 200 and/or the database 235 may comprise one or more additional systems and/or may be distributed across multiple servers, multiple cloud-bases servers, datacenters, or any combination thereof (not shown in the drawings). The at least one AI-based resource and/or MLS-based resource may be accessible and/or activatable by the scanner 210, the computer 220, and/or the 3D printing system 245 via the database 235 over the networks 240A, 240B.

A memory, digital storage device and/or non-transitory computer-readable medium (i.e., the medium 225), which may be accessed and/or executed by a microprocessor incorporated into or included within the system 200, the scanner 210, the computer 220, and/or the 3D printing system 245, may have stored thereon executable computer-implemented instructions (i.e., the computer instructions 230), computer programs, one or more algorithms and/or software that, when executed by the microprocessor, perform one or more computer-implemented steps and/or sub-steps of the present processes disclosed herein. In embodiments, the computer instructions 230, executable instructions, computer programs, algorithms, and/or software may be AI-based and/or MLS-based or -optimized executable instructions, computer programs, algorithms, and/or software. The present AI-based and/or MLS-based applications, software, and/or tools may be executed by the scanner 210, the computer 220, and/or the 3D printing system 245 via the AI-based and/or MLS-based or -optimized executable instructions, computer programs, algorithms, and/or software. In some embodiments, the AI-based and/or MLS-based or -optimized executable instructions, computer programs, algorithms, and/or software may be accessible and/or executable locally with respect to the scanner 210, the computer 220, and/or the 3D printing system 245. In at least one embodiment, the AI-based and/or MLS-based or -optimized executable instructions, computer programs, algorithms, and/or software may be accessible and/or executable via a cloud-based server over the networks 420A, 420B. In some embodiments, the GUIs of the computer 220 may be web-based, for example, with one or more parts of one or more pages being loaded or may natively-compiled to execute on the computer 220, even when the networks 240A, 240B may not be or are not available to the computer 220.

In embodiments, the networks 240A, 240B may be, for example, a personal area network (PAN), a local area network (LAN), a campus area network (CAN), a Metropolitan area network (MAN), a wide area network (WAN) and/or the like. In an embodiment, the networks 240A, 240B may be a wireless network, such as, for example, a 5G+ network, a 5G network, a 4G network, a 3G network, a wireless MAN, a wireless LAN, a wireless PAN, a Wi-Fi network, a WiMAX network, a global standard network, a personal communication system network, a pager-based service network, a general packet radio service, a universal mobile telephone service network, a radio access network and/or the like. In an embodiment, the networks 240A, 240B may be a fixed network, such as, for example, an optical fiber network, an Ethernet, a cabled network, a permanent network, a power line communication network and/or the like. In another embodiment, the networks 240A, 240B may be a temporary network, such as, for example, a modem network, a null modem network and/or the like. In yet another embodiment, the networks 240A, 240B may be an intranet, extranet or the Internet which may also include the world wide web. The present disclosure should not be limited to a specific embodiment of the networks 240A, 240B.

The present disclosure should not be deemed as limited to a specific number of scanners, computers, 3D printing systems, digital devices, computer servers, cloud-based servers, databases, digital communication networks, resolvers, user interfaces, AI-based resources/components, and/or MLS-based resources/components which may access and/or may utilize the present systems and/or methods disclosed herein. The present systems and/or methods disclosed herein may include and/or incorporate any number of scanners, computers, 3D printing systems, digital devices, computer servers, databases, digital communication networks, resolvers, user interfaces, AI-based resources/components, and/or MLS-based resources/components as known to one of ordinary skill in the art. In some embodiments, the system 200 shown in FIG. 2 and the process 100 shown in FIG. 1 may include and/or incorporate any number of scanners, computers, 3D printing systems, digital devices, computer servers, databases, digital communication networks, resolvers, user interfaces, AI-based resources/components, and/or MLS-based resources/components as known to one of ordinary skill in the art.

The at least one of the AI-based resource/component, MLS-based resource/component, the AI software, or any combination thereof usable or utilized by the process 100 and/or the system 200 may include or comprise one or more techniques that enable one or more machines or computers of the system 100 (i.e., the computer 220) to mimic at least one human behavior. In embodiments, the one or more techniques may comprise machine MLS-based techniques which are a subset of AI comprising one or more statistical methods to enable the one or more machines or computers of the process 100 and/or system 200 to improve with experience over time. The one or more statistical methods of the present systems and processes disclosed herein are at least one method selected from supervised learning, unsupervised learning, semi-supervised learning, reinforcement learning, deep learning, and at least one combination thereof. Supervised learning may comprise at least one selected from regression, classification, and at least one combination thereof. Unsupervised learning may comprise at least one selected from clustering, dimensionality reduction, and at least one combination thereof. Semi-supervised learning may comprise at least one selected from self-training, one or more low density separation models, one or more graph-based algorithms, and at least one combination thereof. Reinforcement learning may comprise at least one selected from dynamic programming, one or more Monte Carlo methods, one or more Heuristic methods, and at least one combination thereof. Deep learning is a subset of the machine learning (hereinafter “ML”) that is configured, adapted, or programmed to make computations of one or more multi-layer neural networks feasible. Deep learning may comprise at least one artificial neural network selected from at least one recurrent neural network (hereinafter “the RNN”), at least one convolutional neural network, and at least one combination thereof.

Architectures of the at least one AI-based and/or MLS-based resource/component disclosed herein comprises at least one of the RNN and AI software. In some embodiments, the at least one AI-based and/or MLS-based resource/component and/or the AI software, which may be included or incorporated into the computer instructions 230, may be, at least partially or entirely, web-based and/or cloud-based, for example, with one or more parts of AI software being loaded from and/or executable via the medium 225, the database 235, and/or a cloud-based server. Further, the at least one AI-based and/or MLS-based resource/component and/or the AI software may be locally- or natively-compiled to execute on at least one of the scanner 210, the computer 220, and/or the 3D printing system 245 even when the networks 240A, 240B may not be or are not available to the system 200. Alternatively, the at least one AI-based and/or MLS-based resource/component and/or the AI software may be a combination of web-based and locally- or natively-compiled such that the computer 220 and the AI software require fewer computing assets or resources and/or improve AI processing speeds achievable by the systems, methods and/or applications disclosed herein.

The AI software of the present systems and processes disclosed herein may comprise and/or include at least one classifier, model, or network selected from a fully recurrent network, at least one Elman network, at least one Jordan network, a Bayesian network, a Hopfield network, an Echo state network, an independently RNN, a recursive network, a neural history compressor network, a second order RNN, a long short-term memory (hereinafter “LSTM”) network, a gated recurrent unit network, a bi-directional LSTM network, a continuous-time network, a hierarchical network, a recurrent multilayer perceptron network, a multiple timescales model network, at least one neural Turing machine, a differentiable neural computer network, a neural network pushdown automata, at least one memristive network, and at least one combination thereof. In embodiments, the at least one classifier, model, or network may be at least one neural network with a non-conventional number of nodes at one or more layers and/or may comprise one or more hidden layers.

The AI software of the present systems and processes disclosed herein may be accessed, utilized, activated, and/or implemented by at least one of the scanner 210, the computer 220, and/or the 3D printing system 245. As a result, the AI software of the present systems and processes may solve one or more problems associated with developing the treatment plan and/or the force vector matrix or 3D printing the aligner(s) 250. Further, the AI software may power and/or facilitate at least one digitally-rendered avatar or the digital twin of the teeth 205 and/or the scan 215 on the GUIs such that the avatar or digital twin may solve the one or more problems associated with developing the treatment plan and/or the force vector matrix and/or 3D printing the aligner(s) 250.

In embodiments, the present AI-based or MLS-based resource/component and/or the AI software may be performed, executed, and/or implemented either locally or remotely with respect to at least one of the scanner 210, the computer 220, and/or the 3D printing system 245. For example, the present AI applications or tools and/or the AI software may be performed, executed, and/or implemented locally or what is known as IA-on-the-edge. Alternatively, the present AI applications, software, and/or tools may be performed, executed, and/or implemented in a cloud server system or at another remote location.

In embodiments, the present AI applications or tools and/or the AI software may be performed, executed, and/or implemented on at least one AI-based and/or MLS-based hardware (not shown in the drawings). At least one of the system 200, the scanner 210, the computer 220, and/or the 3D printing system 245, may comprise, implement, and/or include or be enabled by the AI-based hardware. Further, the scanner 210, the computer 220, and/or the 3D printing system 245 may be in digital communication with and/or enabled by the AI-based hardware. In some embodiments, the AI-based hardware may be accessed, enabled, and/or activated by the scanner 210, the computer 220, and/or the 3D printing system 245 to implement, execute and/or utilize the AI software of the present systems and processes disclosed herein.

The AI-based hardware disclosed herein may comprise or consist of at least one AI-based or MLS-based central processing unit (hereinafter “CPU”), at least one AI-based or MLS-based graphics processing unit (hereinafter “GPU”), at least one AI-based or MLS-based integrated graphics processor (hereinafter “IGP”), at least one AI-based or MLS-based field programmable gate array (hereinafter “FPGA”), at least one AI-based or MLS-based application specific integrated circuit (hereinafter “ASIC”), or any combination thereof. In embodiments, the AI-based hardware disclosed herein may comprise at least one AI-specific and/or AI-optimized CPU, GPU, IGP, FPGA, ASIC, or any combination thereof. In at least one embodiment, the AI-based hardware disclosed herein may comprise at least one CPU and at least one AI accelerator selected from the group consisting of at least one GPU, at least one FPGA, at least one ASIC, or any combination thereof. For example, the AI-based hardware disclosed herein may be AI-specific integrated circuits and/or AI-optimized GPUs. Further, the AI-based hardware may comprise one or more analog AI cores, one or more AI-optimized systems, one or more AI-optimized computer chips, one or more AI application-specific computer chips, one or more digital AI cores, heterogeneous integration, machine intelligence, ML quantum computing, or at least one combination thereof. Moreover, the AI-based hardware may comprise one or more AI accelerators and/or may be configured and/or adapted such that performance, execution, and/or implementation of the present AI applications tools and/or the AI software may be improved, accelerated and/or increased by the AI-based hardware of the present systems and processes disclosed herein.

In some embodiments, the present systems and processes disclosed herein may utilize, implement, and/or execute one or more of the following computing-based technologies; one or more application programming interfaces (hereinafter “APIs”) providing connections between the scanner 210, the computer 220, the 3D printing system 245, the AI software, the AI-based hardware, or any combination thereof; one or more runtime environments running on an engine and executing code outside application software for accessing the World Wide Web; one or more database management system for maintaining the database 235 and/or additional databases of the system 200 (not shown in the drawings); one or more computing and development tools or platforms for creating mobile applications and/or web applications; one or more computing web services, one or more on-demand cloud computing platforms and/or APIs, one or more payment processing software and APIs for e-commerce websites and mobile application, or any combination thereof. One or more components of the system 200 and/or one or more steps or sub-steps of the process 100 may include, incorporate, execute, and/or utilize the above-mentioned one or more computing-based technologies to achieve the novel and inventive systems and processes disclosed herein.

In embodiment, the one or more computing-based technologies may comprise at least the following computer-based technologies: at least one open-source, cross-platform, back-end JavaScript runtime environment; at least one open-source relational database management system; at least one platform for creating mobile and web applications; at least one storage infrastructure providing object storage through a web service interface; at least one software as a service provider; at least one financial service provider; at least one payment processor; or any combination thereof. For example, the computer-based technologies of the present systems and processes disclosed herein may comprise at least one selected from: Node.js. Prostgres or PostgreSQL; Firebase for generating, transmitting, utilizing one or more notifications; Amazon Web Services Simple Storage Service (hereinafter “AWS S3”) bucket for saving, storing, retrieving, and/or transmitting images of the present systems, methods, and applications disclosed herein; at least one financial services provider, such as, for example, Stripe, Inc.; or any combination thereof. In at least one embodiment, the object storage through the web service interface may store, save, retrieve, and/or transfer digital images of, associated with, and/or indicative of at least one of the teeth 205, the scan 215, the treatment plan, the force vector matrix, the aligner(s) 250, or other imagery relevant to or associated with the systems and processes disclosed herein, or any combination thereof.

In some embodiments, the systems and processes disclosed herein may provide the one or more web-based, cloud-based, and/or AI-enabled platforms and interfaces that allow for the generation of a 3D digital twin of the teeth 205 and/or the scan 215 which is a 3D digital model of the teeth 205 and/or the scan 215, respectively. The 3D digital twin may be developed, created, produced, or provided by the process 100 and/or system 200 based on the teeth 205 and/or the scan 215 and/or may be trained based on the AI software via the AI hardware. After the 3D digital twin has been developed and/or trained via the present process 100 and/or system 200, the treatment plan for the teeth 205 and/or the force vector matrix for the aligner(s) 250 may be developed by the process 100 and/or the system 200 via the developed, trained, and/or modelled 3D digital twin. As a result, the process 100 and/or the system 200 may create, produce, or provide the developed treatment plan and/or the developed force vector matrix based upon the 3D digital twin. The developed treatment plan and/or the developed force vector matrix may be utilized by the process 100 and/or the system 200 to instruct, control and/or manipulate the 3D printing system 245 such that the 3D printing system 245 prints, creates, produces, or provides the aligner(s) 250 for treating the teeth 205. In at least one embodiment, the fabrication instructions transmitted to or received by the 3D printing system 245 for producing the aligner(s) 250 are based upon, or at least partially based upon, at least one of the teeth 205, the scan 215, the developed treatment plan, the developed force vector matrix, one or more inputs from the teeth 205, the scan 215, and/or the developed treatment plan, the developed, trained, and/or modelled 3D digital twin, or a combination thereof.

In one or more embodiments, the scanner 210 may comprise, include, consist of, and/or may be a dental 3D scanner, an intraoral scanner, a hand-held dental scanner, a stand-alone dental scanner, a trios dental scanner, a dental CT scanner, a dental CBCT scanner, or a combination thereof. Additionally, the scan 215 may comprise, include, consist of, and/or may be one or more 3D digital impressions of the teeth 205, one or more 3D digital images of the teeth 205, at least one 3D digital impression of an oral cavity of the patient, at least one 3D digital model of the teeth 205, one or more 3D colorized images of the teeth 205, or a combination thereof. In at least one embodiment, the scan 215 may be a 3D digital model of the teeth 205 that may be or may have been processed by scanning software techniques associated with, accessible by, and/or executable by the scanner 210, the computer 220, the medium 225, the computer instructions 230, the database 235, or a combination thereof. Further, the 3D printing system 245 may be, comprise, include, consist of, and/or have a 3D printer, a 3D printing system, or a combination thereof, and/or the 3D printing system 245 may utilize at least one additive manufacturing process to produce the aligner(s) 250, at least one portion, section, or part of the kit 255, or a combination thereof. In an embodiment, the at least one additive manufacturing process may be, comprise, include, and/or consist of at least one 3D printing technique, at least one VAT photopolymerization technique, at least one material jetting technique, at least one binder jetting technique, at least one powder bed fusion technique, at least one material extrusion technique, at least one directed energy deposition technique, at least one sheet lamination technique, or a combination thereof. Moreover, the computer instructions 230 may be, comprise, include, and/or consist of software selected from processing software, scanning software, modeling software, development software, training software, artificial intelligence and/or machine learning software, additive manufacturing software, 3D printing software, fabrication software or instructions for producing the aligner(s) 250, digital twin and/or avatar (hereinafter “the digital twin”) generation software, digital twin development software, digital twin training and/or re-training software, or a combination thereof.

In an initial step of the process 100, the patient's existing oral situation will be scanned and fed to software running on a computer to produce, make or provide the scan 215.

Separately, the practitioner will develop a treatment plan for desirable movements of one or more of the teeth 205 from their existing (“original”) or first position or location to a new (“treated”) or second position or location.

To assist in fabricating the aligner to execute these movements, the practitioner will take advantage of software and/or the computer instructions 230 disclosed herein that may incorporate and process one or more inputs combined from the scan 205 of the existing oral situation and a force vector matrix developed, produced, or provided by the software and/or computer instructions 230 disclosed herein. The force vector matrix disclosed herein may comprise one or more combined inputs of all variables that are known to contribute to force generation of the aligner(s) 250 on the teeth 205 of the patient and, thus, will accommodate for multiple variables, such as, for example, but not limited to, resin type(s) used for 3D printing the aligner(s) 250 (hereinafter “the printed aligner(s) 250”), post-processing of the printed aligner(s) 250, direction and magnitude of tooth movement, optionally the surface area of at least one individual tooth of the teeth 205, optionally one or more areas of undercuts or angles of the patient's tooth anatomy that may be advantageous or disadvantageous to tooth movement, optionally force decay of the printed aligner(s) 250, optionally the effect of the gradient of thickness on the resulting forces, and optionally also patient age, bone density and other pertinent information with respect to the patient and/or the teeth 205 of the patient. Based upon these inputs, the software or computer instructions 230 disclosed herein may determine one or more optimal topographical features, for example, one or more optimal thicknesses of the printed aligner(s) 250 at various points of the printed aligner(s) 250 that may provide forces that are considered optimal for carrying out the treatment plan and obtaining physiologic orthodontic tooth movement.

Software or computer instructions 230 disclosed herein may provide the fabrication instructions to the 3D printer or the 3D printing system 245 that may or will selectively light cure liquid resin into a solid surface of the printed aligner(s) 250. Typically, this may be done or facilitated by an “offset” feature of the software or computer instructions 230 disclosed herein, such as, for example, but not limited to, a “thickening” feature, “Boolean split”, or a combination thereof. The result may be, include, comprise, or consist of a 3D printed dental aligner or the printed aligner(s) 250 that may be characterized by exceptional accuracy and utility. In some embodiments, the printed aligner(s) 250 created, produced, manufactured, and/or provided by the present systems and processes disclosed herein may one or more 3D printed clear dental aligners or appliances. Because the developed, created, or provided force vector matrix disclosed herein takes into account essentially all variables that contribute to force generation, the printed aligner(s) 250 obtained by the present systems and processes may provide at least one dental aligner or appliance that carries out, as closely as is possible, the desired or developed treatment plan associated with the teeth 205 of the patient.

In some embodiments, the printed aligner(s) 250 may achieve and/or exhibit consistent and/or predictable final thicknesses throughout one or more portions or section of the printed aligner(s) 250. For example, final thicknesses of the printed aligner(s) 250 may be from about 0.2 mm to about 1.2 mm, from about 0.4 mm to about 1.0 mm, from about 0.4 mm to about 0.6 mm, or from about 0.9 mm to about 1.1 mm. In an embodiment, the printed aligner(s) 250 may achieve thickness losses after 3D printing from about −15% to about +15%, from about −10% to about +10%, or from about −5% to about +5%. In some embodiments, the printed aligner(s) 250 may apply average forces over a 7-day time period to at least one tooth or more than one tooth of the teeth of the patient. For example, the average forces may range from about 40 grams to about 120 grams, from about 50 grams to about 100 grams, or from about 60 grams to about 80 grams. In an embodiment, the averages forces may be about 40 grams, about 60 grams, about 80 grams, about 100 grams, or about 120 grams.

The printed aligner(s) 250 may have, comprise, or consist of one or more shape memory properties, one or more super elasticity properties, or a combination thereof. For example, the printed aligner(s) 250 may retain shape memory such that the shape memory properties of the printed aligner(s) 250 may be reactivated by submerging the printed aligner(s) 250 in warm or hot water. As a result, the printed aligner(s) 250 may return to the original shape and/or the original strength associated the printed aligner(s) 250 before being worn in the mouth of the patient.

In one or more embodiments, the scan 215 of the teeth of the patient, the developed treatment plan, and/or the developed force vector matrix may determine, provide, and/or calculate the force properties that the printed aligner(s) 250 must necessary have to move one or more teeth of the patient from a original or first position to a new or second position according to the developed treatment plan. For application of the force properties onto the one or more teeth of the patient, the printed aligner(s) 250 may have at least one force augmentation geometry to move the one or more teeth of the patient from the original or first position to the new or second position according to the developed treatment plan.

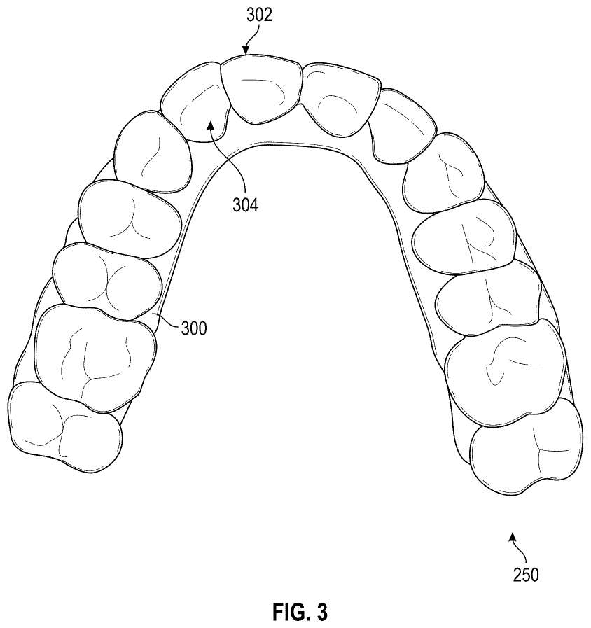

FIGS. 3 and 4 show perspective top and side view of the printed aligners 250, wherein the printed aligner(s) 250 have one or more exterior surfaces 300 (hereinafter “exterior surfaces 300”), one or more outer surfaces 302 (hereinafter “outer surfaces”), and one or more inner surfaces 304 (hereinafter “inner surfaces 304”) located opposite with respect to the outer surfaces 302. When the printed aligner(s) 250 is worn in the mouth of the patient, the outer surfaces 302 are adjacent, contacting, or abutting front sides of the teeth of the patient and face lips and/or cheeks of the patient and the inner surfaces 304 are adjacent, contacting, or abutting back sides of the teeth of the patient and face the tongue and throat of the patient. The printed aligner(s) 250 have one or more interior surfaces 306 (hereinafter “interior surfaces 306”), as shown in FIGS. 12 and 13, wherein, the printed aligners(s) 250 is worn in the mouth of the patient, the interior surfaces 306 directly contact and/or abut the teeth and/or gums of the patient such that the interior surfaces 306 may be configured and/or adapted to move one or more teeth of the patient according to the developed force vector matrix and/or the developed treatment plan.

In an embodiment, the at least one force augmentation geometry for moving the one or more teeth of the patient may be, comprise, or consist of the interior surfaces 306 of the printed aligner(s) 250. As a result, the interior surfaces 306 may have a rigidity and/or stiffness based on the force properties such that the interior surfaces 306 may apply the necessary force to the one or more teeth and move the one or more teeth from the original or first position to the new or second position. In an embodiment, force(s) of the force properties determined, provided, and/or calculated by the scan of the teeth 205, the developed force vector matrix, and/or the developed treatment plan may be applied to the one or more teeth of the patient via the interior surfaces 306 of the printed aligner(s) 250 without any additional augmented force(s).

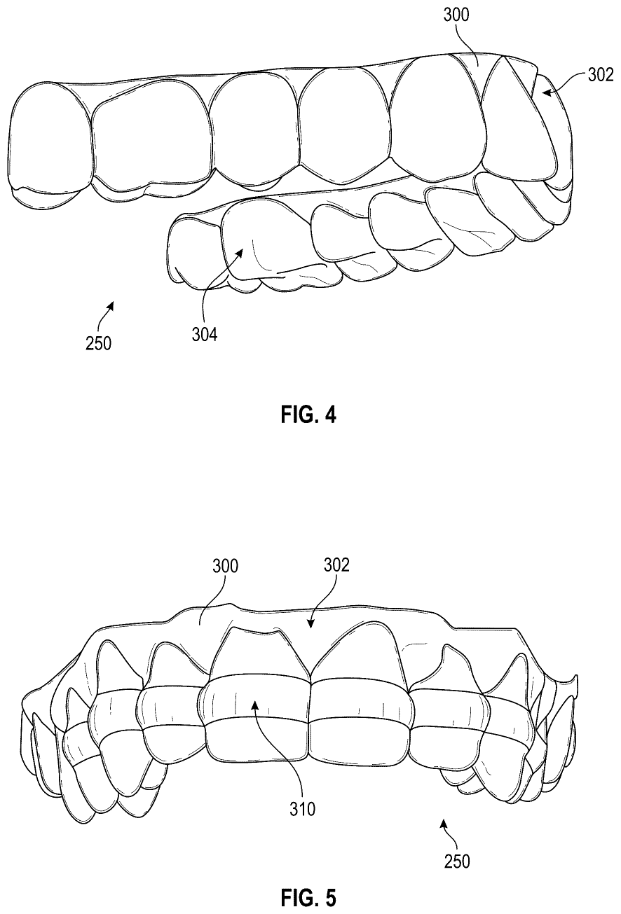

In some embodiments shown in FIGS. 5-9, the at least one force augmentation geometry of the printed aligner(s) 250 may be, comprise, or consist of at least one force augmentation applicator 310, at least one force augmentation booster 310, and/or at least one force augmentation generator 310 (collectively referred to hereinafter as “force augmentation generator 310”). Force(s) of the force properties determined, provided, and/or calculated by the scan of the teeth 205, the developed force vector matrix, and/or the developed treatment plan may be applied to the one or more teeth of the patient via the force augmentation generator 310. As a result, the force(s) applied to the one or more teeth of the patient by the force augmentation generator 310 may move the one or more teeth of the patent from the original or first position to the new or second position according to the developed treatment plan. A variety of different geometries of the force augmentation generator 310 may be incorporated into, included within, coupled to, removably attached to, removably insertable into, and/or utilized with the printed aligner(s) 250. In some embodiments, the different geometries of the force augmentation generator 310 may include, but are not limited to, one or more cylinders, one or more squares, one or more rectangles, on or more bars, one or more bands, one or more bridges, one or more 3D objects or geometries, or a combination thereof. One 3D object that may be advantageous is or may comprise an accordion-shaped 3D object or an at least partial accordion-shaped 3D object. One or more multiple folds of the accordion-shaped 3D object may lead to greater distances of force activation and may likely only be 3D printable or only obtainable by at least one additive manufacturing technique.

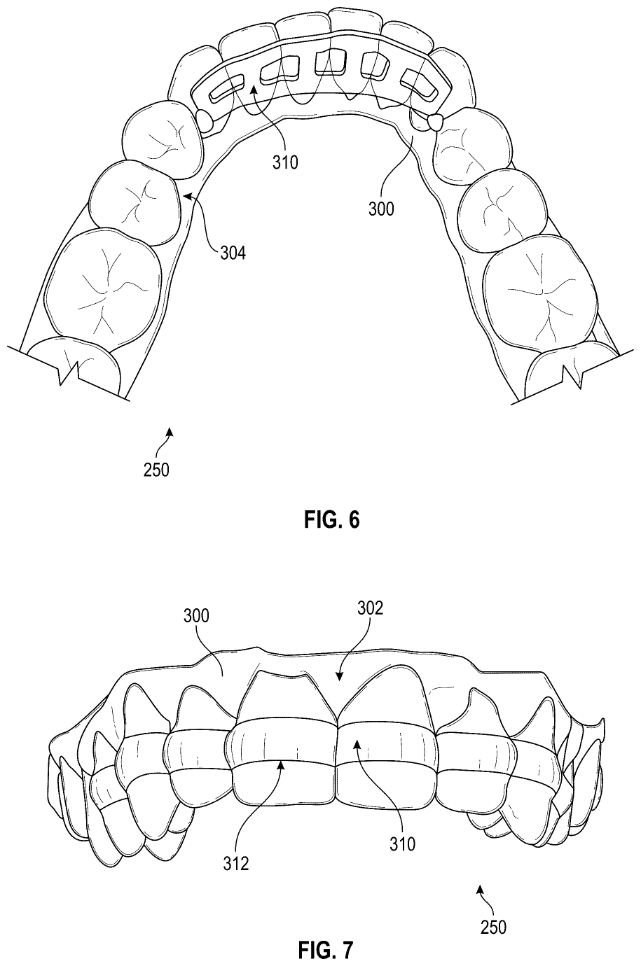

In some embodiments shown in FIGS. 5 and 6, the force augmentation generator 310 may be integrally-formed with the printed aligner(s) 250. For example, force augmentation generator 310 may disposed on and/or integrally-formed with the exterior surfaces 300. In one or more embodiments, the force augmentation generator 310 may be disposed on and/or integrally-formed with the outer surfaces 302 of the printed aligner(s) 250 as shown in FIG. 5. In one or more other embodiments, the force augmentation generator 310 may be disposed on and/or integrally-formed with the inner surfaces 304 of the printed aligner(s) 250 as shown in FIG. 6.

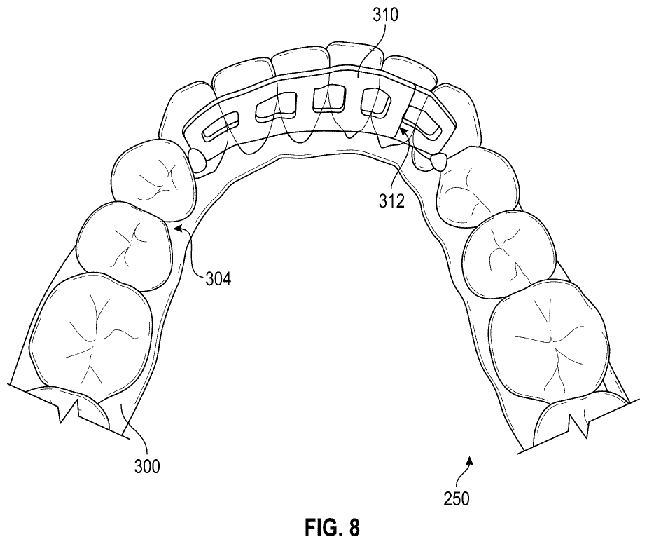

In one or more embodiments, the force augmentation generator 310 may be removably attachable to the exterior surfaces 300 of the printed aligner(s) 250 as shown in FIGS. 7 and 8. For example, the force augmentation generator 310 may removably attachable to the outer surfaces 302 as shown in FIG. 7 or the inner surfaces 304 as shown in FIG. 8. In some embodiments, the exterior surfaces 300 may have, comprise, or consist of at least one housing 312 or at least one receptacle 312 (collectively referred to hereinafter as “receptacle 312”) that may besized, shaped, configured, and/or adapted to receive the force augmentation generator 310 as shown in FIGS. 7 and 8. The force augmentation generator 310 may be inserted into, slid into, snapped into the receptacle 312 and, as a result, the force augmentation generator 310 may be removable attached to the printed aligner(s) 250. With the force augmentation generator 310 removably attached to the printed aligner(s) 250, the force(s) of the force properties may be applied to the one or more teeth of the patient via the force augmentation generator 310 and/or printed aligner(s) 250. As a result, the force(s) applied to the one or more teeth of the patient by the force augmentation generator 310 and/or the printed aligner(s) 250 may move the one or more teeth of the patent from the original or first position to the new or second position according to the developed treatment plan.

In some embodiments, the receptacle 312 of the printed aligner(s) 250 may be, comprise, or consist of one or more openings, one or more holes, one or more slots, one or more grooves, one or more slats, one or more tabs, one or more ridges, one or more lips, one or more pins, one or more flanges, one or more edges, one or more surfaces, or a combination thereof. The force augmentation generator 310 may have a perimeter and/or outer edge surfaces that may match, correspond to, and/or couple with one or more edges and/or one or more surfaces of the receptacle 312 such that the force augmentation generator 310 may couple to the receptacle 312 and/or the force augmentation generator 310 may be removable attached to the receptacle 312.

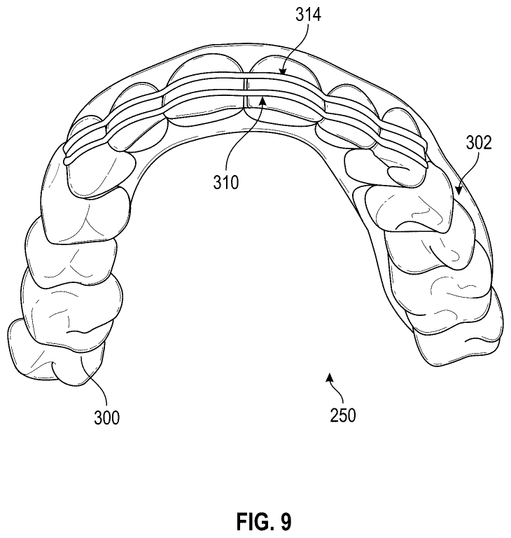

In one or more embodiments, the force augmentation generator 310 may comprise at least one force augmentation band (see FIGS. 5 and 7), at least two force augmentation bands (see FIG. 9), or a plurality of force augmentation bands. At shown in FIG. 9, the force augmentation generator 310 may have, comprise, or consist of outer surfaces 314 that face away from the outer surfaces 302 of the printed aligner(s) 250. In some embodiments, the outer surfaces 314 of the force augmentation generator 310 may be elevated with respect to the outer surfaces 302 of the printed aligner(s) 250. The elevated outer surfaces 314 of the force augmentation generator 310 may face, contact, or abut the lips or cheeks of the patient when the printed aligner(s) 250 is worn in the mouth of the patient.

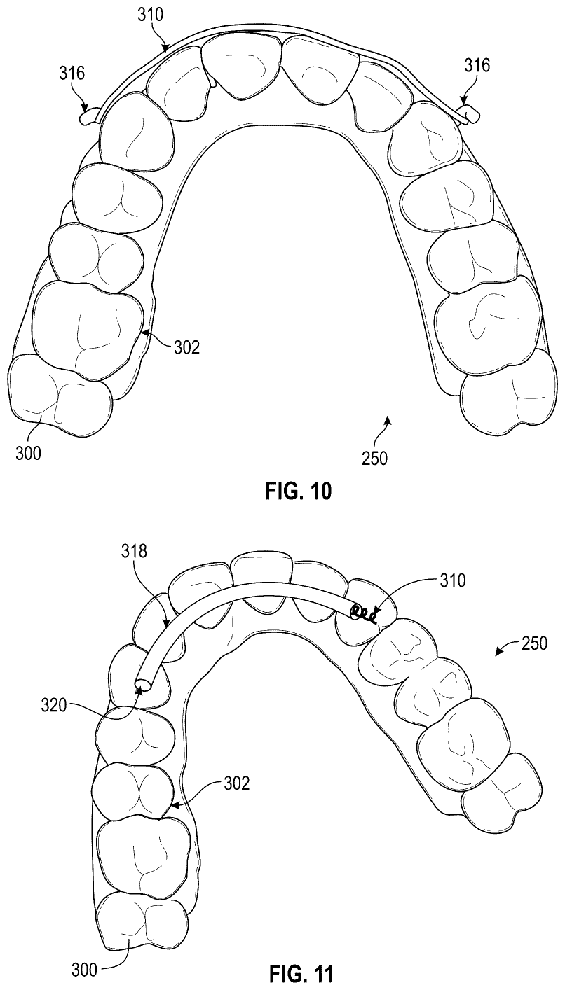

In some embodiments, exterior surfaces 300 of the printed aligner(s) 250 may have, comprise, or consist of one or more fasteners 316 (hereinafter “fasteners 316”) as shown in FIG. 10. For example, the fasteners 316 may be disposed on and/or integrally-formed with the outer surfaces 302 such that the fasteners 316 may extend outwardly away from the outer surfaces 302. In one or more embodiments, the force augmentation generator 310 may be removable attachable to the printed aligner(s) 250 via the fasteners 316. With the force augmentation generator 310 removably attached to the printed aligner(s) 250 via the fasteners 316, the force(s) of the force properties may be applied to the one or more teeth of the patient via the force augmentation generator 310, the fasteners 316, and/or printed aligner(s) 250. As a result, the force(s) applied to the one or more teeth of the patient by the force augmentation generator 310, the fasteners 316, and/or the printed aligner(s) 250 may move the one or more teeth of the patent from the original or first position to the new or second position according to the developed treatment plan.

In one or more embodiments, the fasteners 316 may be, comprise, or consist of one or more hooks, one or more pins, one or more lips, one or more flanges, one or more ridges, one or more clips, one or more peaks, one or more posts, one or more tabs, or a combination thereof. In some embodiments, the force augmentation generator 310 may be one or more elastic and/or rubber bands. In an embodiment, the force augmentation generator 310 may stretch over and/or around or clipped to the fastener 316 such that the force augmentation generator is removable attached to the printed aligner(s) 250 via the fastener 316. For removal, the force augmentation generator 310 may be stretched over or unclipped from the fastener 316 such the force augmentation generator is detached from the printed aligner(s) 250.

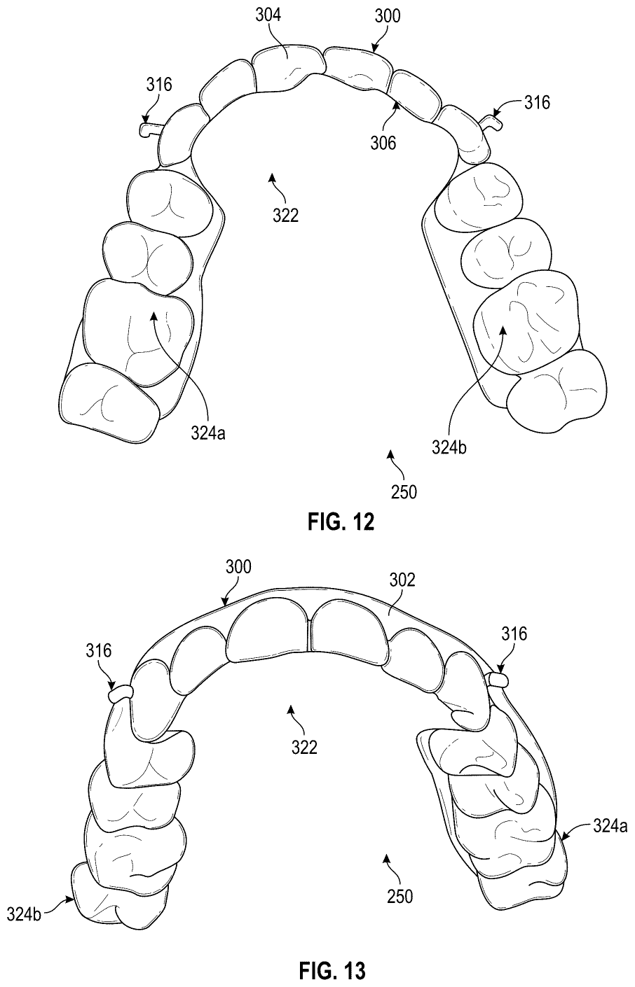

In some embodiments, the exterior surfaces 300 of the printed aligner(s) 250 may have, comprise, or consist of at least one housing 318, at least one receptacle 318, and/or at least one tunnel 318 (collectively referred to hereinafter as “tunnel 318”). In one or more embodiments, the tunnel 318 may be disposed on and/or integrally formed with the inner surfaces 304 of the printer aligner(s) 250 as shown in FIG. 11. For example, the tunnel 318 may have a passageway 320 therethrough which may receive the force augmentation generator 310 to removable attach the force augmentation generator 310 to the printed aligner(s) 250. Further, the tunnel 318 and/or the passageway 320 may be sized, shaped, configured, and/or adapted to receive and/or house the force augmentation generator 310 therein. In an embodiment, the force augmentation generator 310 may be inserted into, slid within, and/or pushable into the passageway 320 or the tunnel 318 such that the force augmentation generator may be removable attached to the printed aligner(s) 250. In some embodiments, the force augmentation generator 310 may be, comprise, or consist of an insertable and/or slidable coil, spring, wire, or combination thereof. In an embodiment, the force augmentation generator 310 may be, comprise, or consist of at least one open coil spring, at least one nitinol wire, or a combination thereof. With the force augmentation generator 310 removably attached to the printed aligner(s) 250 via the tunnel 318 and/or the passageway 320, the force(s) of the force properties may be applied to the one or more teeth of the patient via the force augmentation generator 310, the tunnel 318, and/or printed aligner(s) 250. As a result, the force(s) applied to the one or more teeth of the patient by the force augmentation generator 310, the tunnel 318, and/or the printed aligner(s) 250 may move the one or more teeth of the patent from the original or first position to the new or second position according to the developed treatment plan.

In one or more embodiments, the printed aligner(s) 250 may have at least one recess 322 disposed between two portions or sections of the printed aligner(s) 250 as shown in FIGS. 12 and 13. In some embodiments (not shown in the drawings), the printed aligner(s) 250 may have more than one recess disposed between more than two portions or sections of the printed aligner(s) 250. The recess 322 may be formed, disposed, and/or provided on the side of the printed aligner adjacent to the inner surfaces 304 of the print aligner(s) 250 as shown in FIGS. 12 and 13. When the recess 322 is provided, the inner surfaces 304 may be partitioned, divided, and/or separated into at least two portion 324a, 324b of the inner surfaces 304. Thus, the tongue of the patient may contain back sides of one or more of the front teeth of the patient when the printed aligner(s) 250 with the recess 322 is worn in the mouth of the patient. As a result of wearing the printed aligner(s) 250 with the recess 322, the patient may speak clearly and/or without any speech impediment or with a substantially reduced speech impediment.

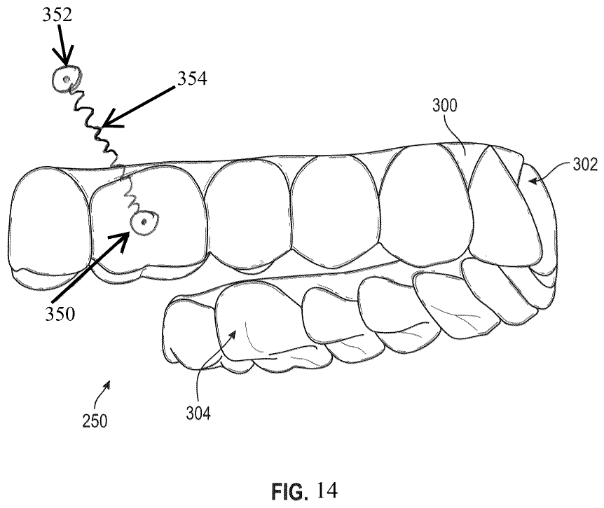

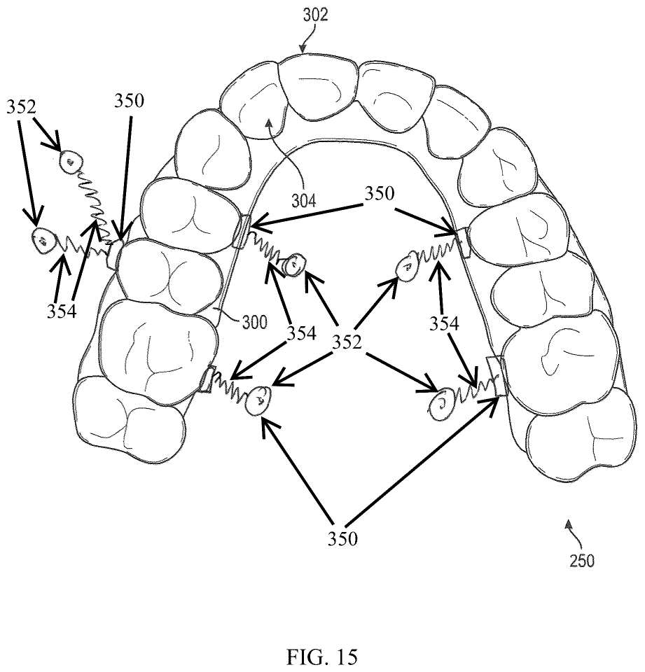

In at least one embodiment, the printed aligner(s) 250 may have at least one fastener 316 disposed on the outer surfaces 302 of the printed aligner(s) 250 and the fastener 316 and/or the printed aligner(s) 250 may be attached, connected, fastened, and/or coupled to at least one tooth and/or at least one bone anchored implant for moving one or more teeth of the patient when the printed aligner(s) 250 is worn in the mouth of the patient. For example, at least one fixture 350 may be disposed on the outer surfaces 302 of the printed aligner(s) 250 and the fixture 350 and/or the printed aligner(s) 250 may be attached, connected, fastened, and/or coupled to at least one tooth or at least one anchored implant 352 (collectively referred to hereinafter after as “the at least one anchored implant 352 via at least one force modulus 354 when the printed aligner(s) 250 is worn in the mouth of the patient as shown in FIG. 14. As a result, the printed aligner(s) 250 shown in FIG. 14 may move at least one tooth or more than one teeth of the patient when the printed aligner(s) 250 is worn in the mouth of the patient and connect or attached to the tooth or the at least one anchored implant 352 via the at least one fixture 350 and/or the at least one force modulus 354.

In some embodiments, the at least one fixture 350 may be formed, provided, and/or 3D printed on the outer surfaces 302 and/or may be, comprise, or consist of one or more hooks, one or more pins, one or more lips, one or more flanges, one or more ridges, one or more clips, one or more peaks, one or more posts, one or more tabs, or a combination thereof. In an embodiment, the at least one fixture 350 may be integrally-formed with the printed aligner(s) 250 and/or the outer surfaces 302 of the printed aligner(s) 250. Further, the at least one force modulus 354 may be, comprise, or consist of one or more springs, one or more coils, one or more elastic and/or rubber bands, or a combination thereof. Moreover, the at least one force modulus 354 may apply force(s) onto one or more teeth of the patient and/or may move the one or more teeth of the patient from the first position to the second position when the printed aligner(s) 250 is worn in the mouth of the patient and the printed aligner(s) 250 is connected or attached to a tooth or the at least one anchored implant 252 via the at least one fixture 350 and/or the at least one force modulus 354.

In one or more embodiments, the printed aligner(s) 250 may have one or more fixtures 350 disposed on the outer surfaces 302 and/or one or more fixtures 350 disposed on the inner surfaces 304 of the printed aligner(s) 250, as shown in FIG. 15. A plurality of force modulus 354 may connect, attach, fasten, or couple the plurality of fixtures 350 to one or more teeth and/or one or more anchored implants 352 to apply force onto and/or to move one or more teeth of the patient from the first position to the second position when the printed aligner(s) 250 shown in FIG. 15 is worn in the mouth of the patient. As a result, one or more teeth of the patient may be moved from the first position to the second position by the printed aligner(s) 250 shown in FIG. 15.

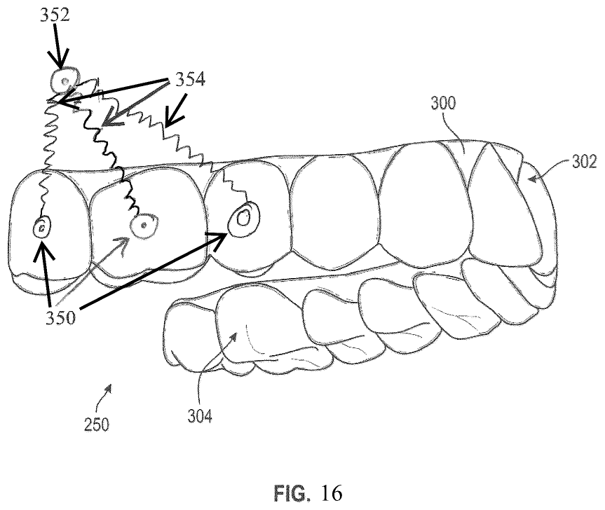

In at least one embodiment, the printed aligner(s) 250 may have a plurality of fixtures 350 disposed on the outer surfaces 302 (as shown in FIG. 16) and/or the inner surfaces 304 (not shown in the drawings) of the printed aligner(s) 250. A plurality of force modulus 354 may connect, attach, fasten, or couple the plurality of fixtures 350 to at least one tooth and/or at least one anchored implant 352 to apply force onto and/or to move one or more teeth of the patient from the first position to the second position when the printed aligner(s) 250 shown in FIG. 16 is worn in the mouth of the patient. As a result, one or more teeth of the patient may be moved from the first position to the second position by the printed aligner(s) 250 shown in FIG. 16. In some embodiments, the present AI-based and/or MLS-based applications, software, and/or tools disclosed herein may prepare, provide, and/or facilitate 3D printing of at least one series of printed aligners 250 and/or at least one plurality of printed aligners 250 (collectively referred to hereinafter as “plurality of printed aligners 250 in accordance with, according to, and/or based on at least one of, or at least partial one of the scan of the teeth 205, the developed treatment plan, the developed force vector matrix, the determined, provided, and/or calculated force properties, the force(s) of the determined, provided, and/or calculated force properties, or a combination thereof. The plurality of printed aligners 250 may have, comprise, or consist of a number of printed aligners 250 necessary to complete or achieve, or at least partial complete or achieve, the developed treatment plan, wherein one or more teeth of the patient are moved or adjusted from an original or first position to a final or last position according to the developed treatment plan or to at least an intermediate position located between the original or first position and the final or last position. In some embodiments, the number of printed aligners 250 of the plurality of printed aligners 250 may be about (3) printed aligners 250, about five (5) printed aligners 250, about ten (10) printed aligners 250, about fifteen (15) printed aligners 250, about twenty (20) printed aligners, or about twenty-five (250) printed aligners 250

In one or more embodiments, the present AI-based and/or MLS-based applications, software, and/or tools are usable to prepare, provide, produce, and/or facilitate the 3D printing of the plurality of printed aligners 250 according to and/or based on the developed treatment plan, wherein each printed aligner 250 of the plurality of printed aligners 250 may have, comprise, or consist of, in accordance with and/or based on the developed treatment plan, at least one selected from at least one force augmentation geometry, at least one force augmentation generator 310, at least one receptacle 312, at least one fastener 316, at least one tunnel 318, at least one passageway 320 of the tunnel 318, at least one recess 322, or a combination thereof. In some embodiments, the present AI-based and/or MLS-based applications, software, and/or tools disclosed herein may be usable to prepare, provide, produce, generate, and/or create fabrication instructions (i.e., computer instructions) to facilitate the 3D printing of each printed aligner 250 of the plurality of printed aligners 250 in accordance with and/or based on the developed treatment program. The fabrication instructions for each printed aligner 250 may be transmitted, send, and/or delivered to the 3D printer or the 3D printing system 245, wherein the 3D printing system 245 may 3D print each printed aligner 250 of the plurality of printed aligners 250. Each printed aligner 250 of the plurality of printed aligners 250 (via the at least one force augmentation geometry, the force augmentation generator 310, the receptacle 312, the fasteners 316, the tunnel 318, or a combination thereof) may apply the forces according to and/or based on the developed treatment plan onto one or more teeth of the patient such the applied forces may incrementally, gradually, gradationally, and/or step-by-step move the one or more teeth of the patient from the original or first position to the final or last position when the plurality of printed aligners have been worn in the mouth of the patient and/or to one or more intermediate positions located between the original or first position and the final or last position after at least one printed aligner 250 of the plurality of printed aligners 250 have been worn in the mouth of the patient.

In an embodiment, the present AI-based and/or MLS-based applications, software, and/or tools are usable to prepare, provide, produce, and/or facilitate the 3D printing of the plurality of printed aligners 250 comprising three (3) printed aligners 250 consisting of a first printed aligner 250, a second printed aligner 250, and a third printed aligner 250. The plurality of printed aligner 250 is according with and/or based on the scan of the teeth 205 of the patient, the developed treatment plan, the developed force vector matrix, and/or the determined, provided, and/or calculated force properties. The first printed aligner 250 may have, comprise, or consist of a first force augmentation generator 310 disposed at or along a first position or location with respect to the exterior surface 300 of the first printed aligner 250. As a result, the first force augmentation generator 310 may apply a first force to one or more teeth of the patient and/or move the one or more teeth from an original or first position to a first intermediate or second position when the first printed aligner 250 is worn in the mouth of the patient or after the first printed aligner 250 has been worn in the mouth of the patient. The second printed aligner 250 may have, comprise, or consist of a second force augmentation generator 310 disposed at or along a second position or location with respect to the exterior surface 300 of the second printed aligner 250. As a result, the second force augmentation generator 250 may apply a second force to the one or more teeth and/or move the one or more teeth from the first intermediate or second position to a second intermediate or third position when the second printed aligner 250 is worn in the mouth of the patient or after the second printed aligner 250 has been worn in the mouth of the patient. The third printed aligner 250 may have, comprise, or consist of a third force augmentation generator 310 disposed at or along a third position or location with respect to the exterior surface 300 of the third printed aligner 250. As a result, the third force augmentation generator 310 may apply a third force to the one or more teeth and/or move the one or more teeth from the second intermediate or third position to the final or last position when the third printed aligner 250 is worn in the mouth of the patient or after the third printed aligner 250 has been worn in the mouth of the patient. In some embodiments, at least two of the first force, the second force, and the third force may the same or substantially the same amount of force and/or amount of pressure. Further, at least two of the first force, the second force, and the third force may different or substantially different amounts of force and/or amounts of pressure. Moreover, the developed treatment plan for the teeth 205 of the patient is or may be achieved, completed, concluded, and/or finished upon movement of the one or more teeth of the patient to the final or last position according to the developed treatment plan.

In one or more embodiments, at least one method or process of improving the fit of direct fabrication of printed aligner(s) 250 is envisioned. Many patients have areas of undercuts and/or overhanging structures, particularly in the interproximal areas or areas between the teeth 205. The printed aligner(s) 250 may reproduce a negative of these areas of undercuts and/or overhanging structures and thus may cause difficulty for the patient to place and/or remove the printed aligner(s) 250. In one preferred embodiment, a software algorithm associated with the computer instructions 230 may identify and/or quantify these potential problematic areas and then automatically reduce the areas of undercuts and/or overhanging structures of the printed aligner(s) 250 via the fabrication instructions transmitted to the 3D printing system 245. This may be done, facilitated, and/or implemented by blunting the geometries that lead to the overhanging or undercut areas of the printed aligner(s) 250, for example, these problematic areas likely have acute angles. The tip of the acute angle could be blunted or rounded thus reducing the area of undercut and/or overhang with respect to the aligner(s) 250. For some areas of dental anatomy in patients that have recession, there may be an interproximal tunnel that passes from the facial to the lingual surfaces of the teeth 205 below the contacts between two adjacent teeth of the teeth 205. These areas, when directly 3D printing the aligner(s) 250, may create a corresponding bridge that may or must be removed; otherwise, it may be impossible to place the aligner(s) 250 upon the teeth 205 of the patient to execute or facilitate the developed treatment plan.

Software associated with or included in the computer instructions 230 disclosed herein may determine at least one tooth of the teeth 205 in a treatment plan that may exceed a certain threshold based upon at least one magnitude of tooth movement, then the software, systems, and/or processes disclosed herein may produce the aligner(s) 250 which may place the necessary and/or desirable geometries on the teeth 205 in the direction of tooth movement according to the developed treatment plan for the teeth 205.

Alternatively, the force matrix formula may also make suggestions regarding the treatment plan and/or develop the treatment plan for the teeth 205. For example, based upon certain variables, suggestions may be given to optimize or substantially optimize the treatment plan for the teeth 205 by either increasing or decreasing at least one velocity of tooth movement facilitated or achieved by the aligner(s) 250.

In another embodiment, coating one or more surfaces of the aligner(s) 250 with a UV blocking substance prior to UV curing may alter the rigidity of the aligner(s) 250. For example, coating the internal surface of the aligner(s) 250 prior to curing may make an internal surface of the aligner(s) 250 softer and/or more flexible than an outer surface of the aligner(s) 250. In some embodiments, at least one resin or a mixture of at least two resins with different properties may be utilized to produce the aligner(s) 250. As a result, the at least one resin or the mixture of at least two resins may increase, substantially increase, decrease, or substantially decrease one or more physical properties of the aligner(s) 250. Thus, the printed aligner(s) 250 may be more rigid or less rigid and/or may be more esthetically pleasing by making the aligner(s) 250 more clear and/or glossy in appearance. In an embodiment, the clearness and/or glossiness of the aligner(s) 250 may be based upon the at least one resin or the mixture of at least two resins utilized to 3D print the aligner(s) 250.

In another embodiment, the aligner(s) 250 may be flavored, for example, by adding and/or mixing one or more flavoring additives into the at least one resin or the mixture of at least two resins utilized to 3D print or produce the aligner(s) 250. Although the aligner(s) 250 will not be harmful or toxic for patients to wear, it may be likely that a flavor and/or taste of the aligner(s) 250 may or may not be pleasing. Flavoring of the aligner(s) 250 with one or more flavoring additives may counteract the unpleasing taste and/or increase compliance and wear of the aligner(s) 250.

All of the above may be automatically, or substantially automatically, implemented, facilitated, and/or achievable with the one or more advanced software algorithms, the one or more digital twin, and/or the artificial intelligence software associated the computer instructions 230 disclosed herein, but may also allow a user or the patient to modify and/or place the aligner or the aligner 250 manually. Alternatively, modification and/or placement of the aligner or the aligner 250 may be achieved manually, without the one or more advanced software algorithms, the one or more digital twin, and/or the artificial intelligence software, by the user or the patient.

In one or more embodiments, the systems and processes disclosed herein may comprise, include, consist of, produce, manufacture, or provided the kit 255 that may comprise two or more aligners 250. In an embodiment, the kit 255 may comprise two aligners 250, such as, for example, at least one first 3D printed dental appliance and a second 3D printed aligners 250 for achieving, facilitating, and/or implementing the developed treatment plan for the teeth 205. The at least one first 3D printed dental appliance may move, change, push, or pull at least one tooth of the teeth 205 from an original or first position to an intermediate or second position, and the second 3D printed dental appliance may move, change, push, or pull the at least one tooth from the intermediate or second position to a final or third position. The developed treatment plan for the teeth 205 may be completed, terminated, or achieved upon movement of the at least one tooth to the final or third position. In some embodiments, the at least one first 3D printed dental appliance may comprise at least two first 3D printed dental appliance for moving the at least one tooth to at least two intermediate or second positions between the original or first position and the final or third position to complete or achieve the developed treatment plan.

In some embodiments, the present systems and/or processes disclosed herein may be configured, adapted, and/or designed to control one or more physical properties of the aligner(s) 250. For example, the one or more physical properties of the aligner(s) 250 may be adapted, configured, or designed such that one or more physical properties of the aligner(s) 250 may produce one or more optimal orthodontic forces at the body temperature of the patient. In an embodiment, the aligner(s) 250 may be heat activated or heat activatable when either the patient places the aligner(s) 250 in into the mouth or positions the aligner(s) 250 upon the teeth 205 to facilitate completion of the developed treatment plan for the teeth 205. Thus, the aligner(s) 250, when heated to or at the body temperature of the patient, may exert optimal force activation to apply the one or more optimal orthodontic forces upon at least one tooth of the teeth 205 or two or more teeth of the teeth 205 to implement the developed treatment plan or at least a portion of the developed treatment plan.

The disclosure will now be described in greater detail with reference to the following non-limiting examples.

### EXAMPLES

In at least one example, a patient presents crowding of the lower anterior teeth and spaces between their upper teeth. The teeth of the patient are 3D scanned either directly or by taking impression and then scanning the molds comprising the impression. Using orthodontic treatment planning software of the present systems and processes disclosed herein, the scanned teeth are then moved from the initial or first position to the final or second desired positions. In this case, the lower teeth crowding is resolved, and the upper spaces are closed. All patient variables are factored into the developed, produced, or provided force vector matrix that will call upon the database 235 and provide suggestions to a current treatment plan and/or a current appliance design. For example, the suggestion may be or comprise placing or adding an “accordion-shaped” geometry between the upper front teeth as that will aid in the space closure. For the lower teeth, the suggestion may increase or decrease a thickness of the appliance on the lingual surface of the teeth by about 15%, about 20%, about 25%, about 30%, or about 35% as this may be the area that requires the most force application.

Examples in the present disclosure may also be directed to the medium 225 storing computer instructions 230 and executable by one or more processors of the computer 220 via which the medium 225 is accessed. In some embodiments, steps and/or sub-steps of the process(es) (i.e., the process 100) disclosed herein for producing or providing at least one dental aligner and/or tooth movement appliance (i.e., the aligner(s) 250) may be implemented, facilitated, and/or achievable by execution of the computer instructions 230 stored on the medium 225 or the database 235 and/or executable by the scanner 210, the 3D printing system 245, the computer 220, or a combination thereof. The computer instructions 230 may be accessible and/or executable by the computer 220 via the medium 225 and/or the database 235.

A computer-readable media may comprise the computer instructions 230 and/or may be any available media that may be accessed by the computer 220. By way of example, such computer-readable media may comprise RAM, ROM, EEPROM, CD-ROM or other optical disk storage, magnetic disk storage or other magnetic storage devices, or any other medium that may be used to carry or store desired program code and/or software in the form of instructions or data structures and that may be accessed and executable by the computer 220. Disk and disc, as used herein, includes compact disc (CD), laser disc, optical disc, digital versatile disc (DVD), floppy disk and Blu-ray® disc where disks usually reproduce data magnetically, while discs reproduce data optically with lasers associated with and/or in digital communication with the computer 220.

In one or more embodiments, the software implemented aspects of the subject matter claimed below are usually encoded on some form of program storage medium (i.e., the medium 225) or implemented over some type of transmission medium. The program storage medium is a non-transitory medium and may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The claimed subject matter is not limited by these aspects of any given implementation.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. The examples are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the claims and their equivalents below.

1. A process for producing a dental aligner, wherein the process comprises:
(a) making a scan of teeth of a patient;
(b) developing a treatment plan based on the scan of the teeth for moving at least one tooth of the teeth from a first position to a second position;
(c) developing a force vector matrix based on the developed treatment plan, wherein the force vector matrix comprises a plurality of variables that are known to contribute to force generation of an orthodontic appliance on a patient's tooth; and
(d) 3D printing a dental aligner via a 3D printer and based one or more inputs from the scan of the teeth, the developed treatment plan, and/or the developed force vector matrix and comprising a force augmentation geometry, wherein, when the 3D printed dental aligner is worn in the mouth of the patent, the force augmentation geometry applies force(s) onto the at least one tooth of the teeth such that the forces applied by the force augmentation geometry moves the at least one tooth from the first position to the second position.

2. The process of claim 1, wherein
the 3D printed dental aligner comprises one or more exterior surfaces and one or more interior surfaces opposite with respect to the one or more exterior surfaces, and
the force augmentation geometry for applying the force(s) onto the at least one tooth comprises at least one selected from:
the one or more interior surfaces of the 3D printed dental aligner; and
a force augmentation generator disposed on the one or more exterior surfaces of the 3D printed dental aligner.

3. The process of claim 1, further comprising:
moving the at least one tooth from the first position to the second position according to the developed treatment plan with the force(s) applied to the at least one tooth by the force augmentation geometry.

4. The process of claim 2, wherein the force augmentation geometry comprises at least the force augmentation generator for applying the force(s) onto the at least one tooth.

5. (canceled)

6. (canceled)

7. The process of claim 4, further comprising:
integrally-forming a receptacle on the one or more exterior surfaces of the 3D printed dental aligner via the 3D printer, wherein the integrally-formed receptacle is sized and/or shaped to receive the force augmentation generator such that the force augmentation generator is removably attached to the 3D printed dental aligner via the receptacle.

8. The process of claim 7, wherein the force augmentation generator is in a form of at least insertable one bar, at least one insertable band, at least insertable one spring, or at least one insertable wire.

9. The process of claim 8, wherein the integrally-formed receptacle is a tunnel and the force augmentation generator is in the form of at least one insertable spring or at least one insertable wire.

10. The process of claim 4, further comprising:
integrally-forming one or more fasteners on or with the one or more exterior surfaces of the 3D printed dental aligner via the 3D printer, wherein the force augmentation generator is extendible around or over the integrally-formed one or more fasteners such that the force augmentation generator is removable attached to the 3D printed dental aligner via the integrally-formed one or more fasteners.

11. The process of claim 10, wherein the force augmentation generator is at least one extendible elastic or rubber band.

12. The process of claim 11, wherein the integrally-formed one or more fasteners comprise hooks, posts, and/or tabs.

13. A 3D printed dental aligner comprising
an exterior surface and an interior surface opposite with respect to the exterior surfaces, wherein the exterior surface and the interior surface are formed with at least one cured resin material and a 3D printer, wherein the interior surface faces and/or contacts one or more teeth of a patient and outer surfaces of the exterior surface face or contact lips and/or gums of the patient when the 3D printed dental aligner is worn in a mouth of the patient; and
at least one force augmentation generator disposed on the exterior surface, wherein
the at least one force augmentation generator applies force(s) to one or more teeth of the patient based on a developed force vector matrix and moves the one or more teeth of the patient from a first position to a second position when the 3D printed dental aligner is worn in the mouth of the patient, and
the developed force vector matrix is based on a developed treatment plan that is based on a scan of teeth of the patient.

14. The 3D printed dental aligner of claim 13, wherein the exterior surface comprises inner surfaces located opposite with respect to the outer surfaces of the exterior surface, and the at least one force augmentation generator is disposed on the outer surfaces for applying constrictive force(s) to treat spacing between at least two teeth of the patient or the inner surfaces for applying expansive force(s) to treat at least two overlapping teeth of the patient.

15. (canceled)

16. The 3D printed dental aligner of claim 14, wherein the at least one force augmentation generator is removable attachable to the outer surfaces or the inner surfaces of the exterior surface.

17. The 3D printed dental aligner of claim 16, wherein the exterior surface further comprises at least one receptacle integrally-formed on or with the exterior surface via the 3D printer and sized and/or shaped to receive the at least one force augmentation generator such that the at least one force augmentation generator is removably attached to the exterior surface via the at least one receptacle when the at least one force augmentation generator is inserted into the at least one receptacle.

18. The 3D printed dental aligner of claim 17, wherein
the at least one force augmentation generator is in a form of at least one insertable bar, at least one insertable band, at least one insertable spring, or at least one insertable wire, or
the at least one receptacle is a tunnel and the at least one force augmentation generator is in a form of at least one insertable spring or at least one insertable wire.

19. The 3D printed dental aligner of claim 16, wherein the exterior surface further comprises fasteners integrally-formed on or with the exterior surface via the 3D printer and is configured and/or shaped to receive portions of the at least one force augmentation generator such that the at least one force augmentation generator is removably attached to the exterior surface via the fasteners when the at least one force augmentation generator is extended around or over the fasteners.

20. The 3D printed dental aligner of claim 19, wherein the fasteners are hooks and the at least one force augmentation generator comprises one or more elastic or rubber bands.

21. The 3D printed dental aligner of claim 13, further comprising:
at least one fixture disposed on exterior surface, wherein the at least one force augmentation generator is at least one force modulus and, when the 3D printed dental aligner is worn in the mouth of the patient, the at least one force modulus connects the at least one fixture to an anchored implant of the patient.

22. The 3D printed dental aligner of claim 21, wherein the at least one fixture is 3D printed on the exterior surface and comprises at least one hook, at least one pin, at least one lip, at least one flange, at least one ridge, at least one clip, at least one peak, at least one post, at least one tab, or a combination thereof.

23. The 3D printed dental aligner of claim 22, wherein the at least one force modulus comprises one or more springs, one or more coils, one or more elastic and/or rubber bands, or a combination thereof.
